(19) United States
(12) Patent Application Publication
(10) Pub. No.: US 2009/0183756 A1
(43) Pub. Date: Jul. 23, 2009

(54) Ambulatory assistance device with storage

(76) Inventor: Jaime E. Perez, Miami, FL (US)

Correspondence Address: CHRISTOPHER J. VANDAM, P.A., 19600 NE 21 Ct., MIAMI, FL, 33179, US

(21) Appl. No.: 12/016,551

(22) Filed: Jan. 18, 2008

(51) Int. Cl. A61H 3/04

(52) U.S. Cl. 135/67

(57) ABSTRACT

An ambulatory assistance device having in one embodiment a storage assembly and a collapsible walker assembly. The device can transition from a walker mode to a storage mode. The device is particularly adapted for a person with limited mobility during travel.

### II. BACKGROUND OF THE INVENTION

1. Field of the Invention

The present invention relates to ambulatory assistance devices, and more particularly, to ambulatory assistance devices with a storage feature.

2. Description of the Related Art

Several designs for ambulatory assistance devices have been designed in the past. None of them, however, includes an adequate storage compartment integrated into its structure.

Applicant believes that the closest reference corresponds to U.S. Pat. No. 4,974,760 issued to Patricia H. Miller. However, it differs from the present device because the present device includes a storage assembly that is integrated with a mobility assistance device in such a manner that the mobility assistance device can be collapsed and stored with the storage assembly.

Other patents describing the closest subject matter provide for a number of more or less complicated features that fail to solve the problem in an efficient and economical way. None of these patents suggest the novel features of the present invention.

### III. SUMMARY OF THE INVENTION

It is one of the objects of the present device to provide an assistance device for individuals with limited mobility with an increased storage feature integrated with a mobility assistance device.

It is one of the objects of the present device to provide a means for individuals with limited mobility to become more mobile.

It is another object of this device to provide a convenient means for storing an ambulatory assistance device while at the same time providing a means for article storage.

It is still another object of the present device to limit the need for third party assistance by incorporating storage capabilities with a collapsible ambulatory assistance device.

It is yet another object to provide such a device that is inexpensive to manufacture and maintain while retaining its effectiveness.

Further objects of the device will be brought out in the following part of the specification, wherein detailed description is for the purpose of fully disclosing the invention without placing limitations thereon.

### IV. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 is a perspective view of the device;

FIG. 2 is a rear elevation view of the device;

FIG. 3 is a side elevation view of the device;

FIG. 4 is partial side elevation view of the device illustrating a wheel assembly.

FIG. 5 is a partial elevation cross section of the device demonstrating a walker assembly in greater detail.

### V. DETAILED DESCRIPTION OF THE PREFERRED EMBODIMENT

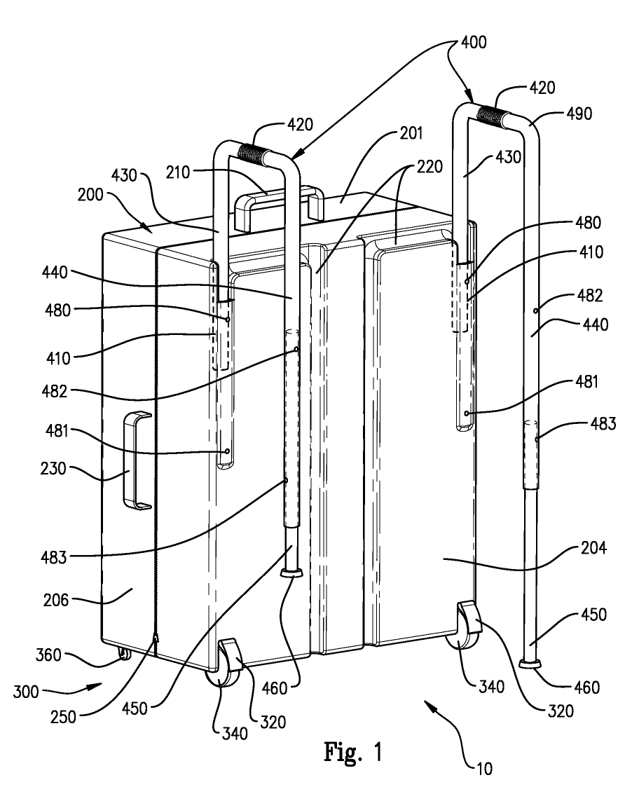

Referring now to the drawings, where the present device is generally referred to with numeral 10, it can be observed in FIG. 1 that the device basically includes a case assembly 200, a wheel assembly 300 and a walker assembly 400.

Said case assembly 200 comprises, inter alia, a top panel 201, a rear panel 204, a panel 206, a handle 210, a handle 230, channels 220 and a zipper 250.

Said wheel assembly 300 comprises, inter alia, wheels 340, wheels 360 and friction brake 320.

Said walker assembly 400 comprises, inter alia, a sleeve 410, a grip 420, a stud 430, a stud 440, a stud 450, a stud 490, a foot 460, a spring clip 470, a spring clip 471, a spring clip 472, a spring 473, bore 480, a bore 481, a bore 482, a bore 483 and a spring 485.

Referring to FIG. 1 where it is shown a zipper 250 that bisects top panel 201 and panel 206 and when unzipped allows accesses to the interior volume of the case assembly 200. Although said zipper 250 is an effective means for accessing and sealing the interior volume of the case assembly 200, other common closure devices could be used instead of the zipper 250 including, for example, buttons, hook and loop fasteners, belts, straps, or other appropriate closure means. The dimensions of said zipper 250 are such that a human hand can grasp the zipper 250 and apply sufficient force to zip or unzip the zipper 250.

Still referring to FIG. 1, channels 220 are shown on the rear panel 204. Said channels 220 are dimensioned to receive the stud 490 and the stud 440 of said walker assembly 400.

Still referring to FIG. 1, said handles 210 and handles 230 provide a gripping means for a user of the device to hold the device. Handle 210 and handle 230 are preferably constructed of a soft and durable material that provides some padding function to a user of the device that may include, for example, cloth, padded metal, composite, plastics, or padded leather. The dimensions of handle 210 and handle 230 are such that a human hand can ergonomically grasp the handle 210 or handle 230 and transport the device. Regardless of the form or material used, said handle 210 and handle 230 are capable of supporting the weight of the device.

In one embodiment of the device the dimensions of said case assembly 200 are determined with respect to airline industry guidelines to permit optimal use, for example as a carry-on luggage. Said case assembly 200 may optionally be made of a cloth skin covering a metallic or hard plastic skeleton, metal, alloy, composite, plastic, or other durable material. As the rear panel 204 is integral with sleeve 410 and the channel 220, a rigid material is preferred for this portion of the device.

Still referring to FIG. 1, Wheels 340 are shown, rotatably affixed to the case assembly 200 near the edge of the rear panel 204 and are spaced apart from each other sufficient to impart stability to the device while in use. Wheels 360 may be rotatably connected to bottom of the device and are spaced apart from each other sufficient to impart stability to the device while in use. Said wheels 340 and wheels 360 may optionally comprise a ball-bearing system to reduce friction and/or may be swiveling casters.

Said friction brake 320 is hingedly connected to the rear panel 204 above either or both wheels 340. Said friction brake 320 is biased away from said wheels 340 by a spring or other suitable means. A user of the device may press her foot onto either or both of said friction brakes 320 to bring the friction brake 320 into contact with said wheels 340 thereby imparting friction on said wheel 340. Operator may supply a minimum amount of force to said friction brake 320 thereby slowing the rotational motion of said wheels 340 or alternatively operator may provide maximum pressure such that rotational motion of wheels 340 is completely stopped. To accommodate a user of the device who has a preference as to which foot they would like to use to engage the friction brake 320, a friction brake 320, may be located adjacent to either wheel 340 and could therefore be engaged with either foot.

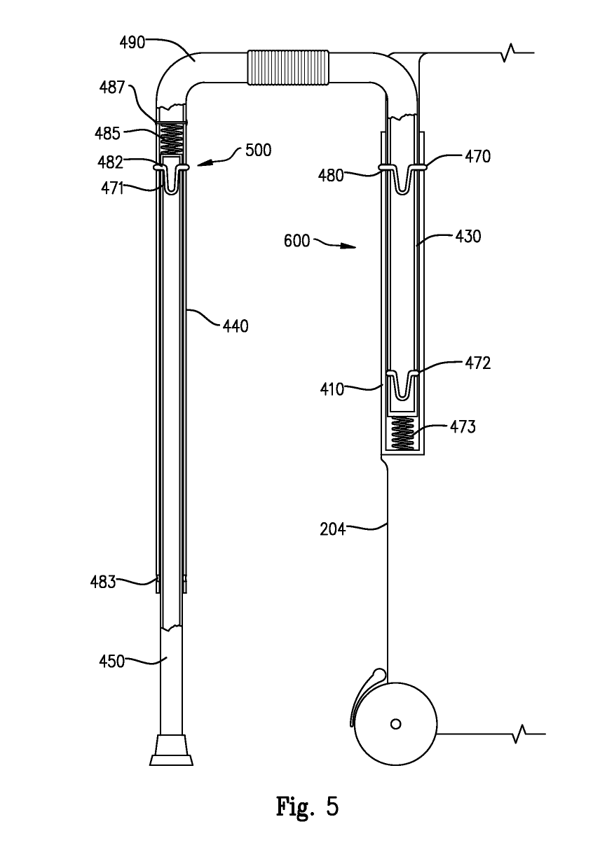

Still referring to FIG. 1, the walker assembly 400 as shown generally comprises sleeves 410, grips 420, studs 430, studs 440, studs 450, studs 490, feet 460, spring clips 470 (shown in FIG. 5), spring clips 471 (shown in FIG. 5), bores 480, bores 481, bores 482 and bores 483.

Each stud 430 is slidably and rotatably nested inside the sleeve 410. Although substantially the entirety of the stud 430 is nested in the sleeve 410, a portion of the stud 430 is not nested in sleeve 410, but rather received by channel 220. The stud 490 is connected to the stud 430 at the upper end of stud 430 and is received by channel 220. The stud 440 is connected to the stud 490 at the end of the stud 490 that is opposite to the connection with stud 430. Stud 440 is substantially parallel to the stud 430. Bore 480 is located on the sleeve 410, towards the lower end of sleeve 410. The bore 481 is located on the sleeve 410 near the top panel 201. It has been demonstrated to be equally or more effective to have additional bores (not depicted in FIG. 1) between bore 480 and 481 to permit stud 430 to be raised to a variety of heights.

When erecting the device into a mode suitable for assisting the mobility of an operator the stud 430 can be pulled up from inside the sleeve 410 and then rotated axially to bring the stud 490 and stud 440 out of the channel 220 and away from the back panel 204 so that the stud 490 is substantially perpendicular to the plane of the back panel 204.

Said grip 420 is located on stud 490 between stud 430 and stud 440. Said grip 420 may be made from a variety of material including for example rubber, cloth, foam, or the like. The foot 460 caps the lower end of stud 450. The foot 460 contacts the ground and provides a non-slip contact to improve the stability of the device. The foot 460 may alternatively be exchanged for a wheel or caster.

The stud 450 is slidably nested inside of stud 440. When the walker assembly 400 is folded against the case assembly 200 the stud 450 is nested into stud 440. When erecting the walker assembly 400, stud 450 is pulled downward from stud 440 until a spring clip 471 in the upper end of stud 450 snaps into bore 483. In typical use of the device stud 450 remains partially engaged into stud 440 by the connection formed by spring clip 471 and bore 483. It has been demonstrated to be equally or more effective to have additional bores (not depicted in FIG. 1) between bore 482 and 483 to permit stud 450 to be extended to a variety of lengths to correspond with the varying height of stud 430.

FIG. 1 generally shows the device in transition between the device in a walker mode and a collapsed mode.

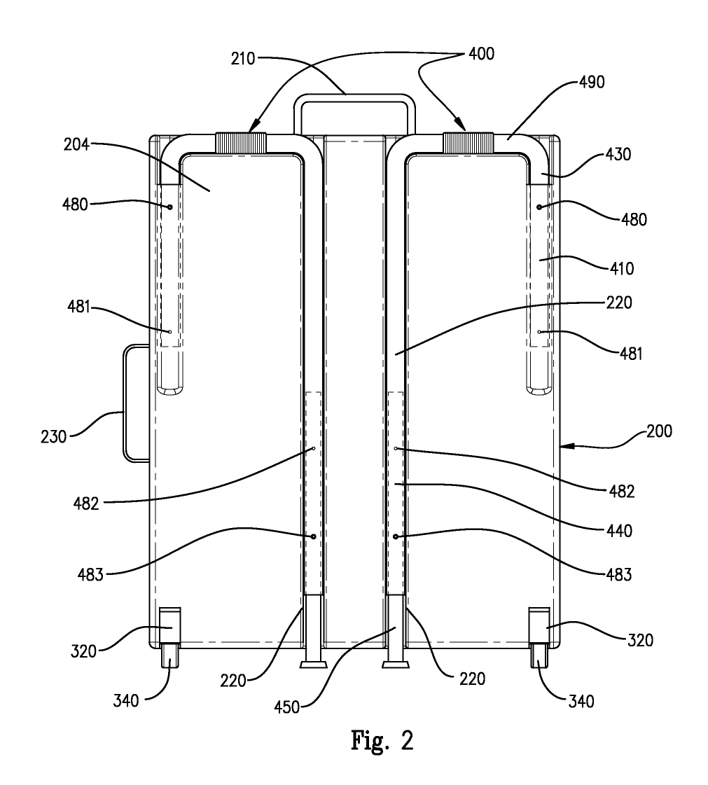

Now referring to FIG. 2, the device is shown in a collapsed mode. Stud 430 is telescopically collapsed in sleeve 410. Stud 450 is telescopically collapsed in stud 440. And the stud 490 and stud 440 are stored in channel 220 such that stud 490 and stud 440 are coplanar with rear panel 204.

When the device is in its collapsed mode, the stud 430 is substantially nested in sleeve 410 and the stud 490 and stud 440 are received in channel 220, as such, the device takes up less space and is less cumbersome to handle by baggage handlers or the like. Therefore it is advantageous to store or transport the device in this mode. The walker assembly 400 is substantially coplanar with the case assembly when the device is in its collapsed mode, thereby giving the case assembly a substantially flat rear panel 204. As such, the device may be stacked on top of another similar device in its collapsed mode if so desired.

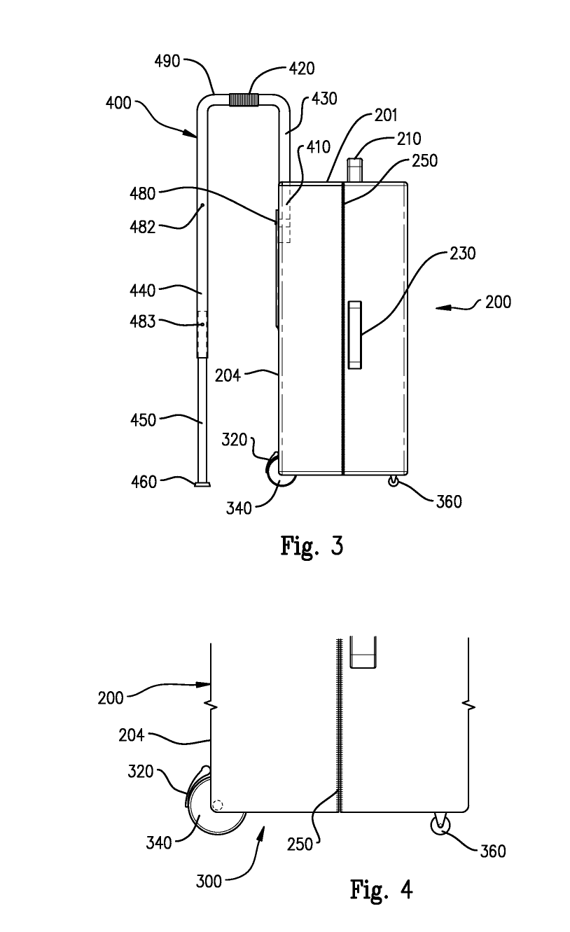

Now referring to FIG. 3, the device is shown in a walker mode. Stud 490 is substantially perpendicular to the plane of the rear panel 204. Stud 430 is telescopically extended from sleeve 410. Stud 450 is telescopically extended from the stud 440.

When the device is in its walker mode, a user of the device can transfer her weight to the walker assembly 400 when engaging in ambulatory movement. By transferring her weight to the walker assembly 400, an operator can reduce the stress and fatigue experienced from unassisted ambulatory movement. As such, an operator may be able to achieve a greater degree of prolonged mobility and autonomy.

FIG. 4 shows a partial side elevation view of the device with wheel assembly 300 shown in greater detail. The wheel 340 is rotatably mounted to the case assembly 200 at the lower edge of the rear panel 204. In its normal state the friction brake 320 is biased away from the wheel 340 permitting the wheel 340 to freely rotate. In FIG. 4 the friction brake 320 is shown to be forced against the wheel 340 as it would be when a user of the device applies foot pressure to slow or stop the wheel 340 from rotating.

Wheel 360 may be a traditional caster and provides balancing support to the device. There may be one or two wheels 360 to provide additional support and balance to the device. Alternative embodiments of the device may exchange the caster wheel 360 for a traditional fixed axis wheel. The wheels 360 are affixed to the bottom panel of the case assembly 200 and spaced apart from each other sufficient to impart stability to the device while in use.

FIG. 5 shows a partial side elevation of an embodiment of the walker assembly 400 further comprising, inter alia, a mechanical extension assembly 500 and a mechanical raising assembly 600.

Said mechanical extension assembly 500 comprises, inter alia, retaining pin 487, a spring 485, a spring clip 471, a bore 482, a bore 483, a stud 440 and a stud 450.

Retaining pin 487 is fixed inside stud 440 such that the longitudinal axis of said retaining pin 487 bisects the center of stud 440. Spring 485 is positioned inside stud 440 such that when stud 450 is telescopically collapsed inside stud 440, said spring 485 is compressed between said retaining pin 487 and the upper end of stud 450. To prevent stud 450 from unintentionally extending telescopically from stud 440, spring clip 471 is engaged into bore 482.

When extending stud 450 from inside stud 440, using said mechanical extension assembly 500, an operator of the device may disengage spring clip 471 from bore 482 by depressing spring clip 471 to allow compression spring 485 to decompress and therefore mechanically extend the stud 450 from the stud 440 until spring clip 471 in the upper end of the stud 450 snaps into bore 483 thereby locking stud 440 relative to stud 450.

Said mechanical raising assembly 600 comprises, inter alia, a sleeve 410, compression spring 473, stud 430, spring clip 472, bore 480, and spring clip 470.

Said spring 473 is positioned inside sleeve 410 such that when stud 430 is telescopically collapsed inside of sleeve 410, said compression spring 473 is compressed between the lower end of sleeve 410 and the lower end of stud 430. To prevent stud 430 from unintentionally extending telescopically from sleeve 410, spring clip 470 engages into bore 480.

When raising stud 430 from inside sleeve 410, using said mechanical raising assembly 600, an operator may disengage spring clip 470 from bore 480 by depressing spring clip 470 to allow compression spring 473 to decompress and therefore mechanically raise the stud 430 from the sleeve 410 until spring clip 472 in the lower end of stud 430 snaps into bore 480 thereby locking stud 430 relative to sleeve 410.

Said mechanical extending assembly 500 and said mechanical raising assembly 600 provides a means for extending the stud 450 from inside the stud 440 and raising stud 430 from inside sleeve 410 that requires substantially less effort from an operator of the device than an alternative embodiment of the device which does not include said mechanical extending assembly 500 and said mechanical raising assembly 600.

When transitioning the device into its walker mode, an operator may erect the walker assembly 400 from its collapsed mode as exemplified in FIG. 2 to its walker mode as exemplified in FIG. 3. Spring clip 470 may be disengaged from bore 480, by depressing spring clip 470 thereby allowing stud 430 to rise up from in the sleeve 410. While spring clip 470 is disengaged from bore 480, the stud 430 may be pulled and telescopically extended within the sleeve 410 until spring clip 472 in the lower end of stud 430 snaps into bore 480. Stud 490 is rotated to substantially perpendicular to the plane of rear panel 204. To telescopically extend the stud 450 from the stud 440, an operator may disengage spring clip 471 from bore 482 by depressing spring clip 471 to allow the stud 450 to telescopically extend from within the stud 450. Stud 450 may be pulled and telescopically extended within the stud 440 until spring clip 471 in the upper end of the stud 450 snaps into bore 483. When stud 450 is fully extended, said foot 460 is in contact with the ground surface.

In transitioning the into its collapsed mode, an operator may collapse the walker assembly 400 from its walker mode as exemplified in FIG. 3 to its collapsed mode as exemplified in FIG. 2. Spring clip 471 may be disengaged from bore 483 by depressing spring clip 471 to allow the stud 450 to telescopically collapse within the stud 440. When spring clip 471 is disengaged, the stud 450 may be slid into the stud 440 until spring clip 471 in the upper end of the stud 450 snaps into bore 482. Spring clip 472 may be disengaged from bore 480 by depressing spring clip 472 to allow the stud 430 to telescopically collapse into the sleeve 410. While spring clip 472 is disengaged with bore 480, an operator may push the stud 430 downward to telescopically collapse the stud 430 into the sleeve 410 until spring clip 470 engages bore 480. When the walker assembly 400 is in its collapsed position, the stud 490 and the stud 440 are housed in channel 220 and are coplanar to the rear panel 204. When the device is in its collapsed mode, it can be carried as if it was a traditional piece of luggage.

Generally in typical use of the device, the device will be carried using handle 210 or handle 230 until an operator decides to transition the device into walker mode. Once the device is transitioned into walker mode, the operator will place herself behind the rear panel 204 and in between the pair of walker assemblies 400. Securely holding grips 420, one in each hand, an operator will place the device in front of her path and transfer her weight to the walker assembly as she moves forward. An operator may slow the movement of the device by applying varying amounts of pressure to the friction brake 320. Once an operator has reached her destination, the walker assembly may be collapsed for easier storage until the operator wishes to use the device again.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An ambulatory assistance device comprising a case assembly that has an open interior volume
said case assembly may be sealed or opened to access said interior volume that may contain personal articles
said case assembly having at least two ground contacting wheels on its lower edge
a walker assembly that further comprises ground contacting studs connected to handles sufficient to be used as a walker
said walker assembly is collapsible and rotatably connected to said case assembly
said walker assembly may be collapsed into a storage mode where said walker assembly is collapsed and rotated against a side of said case assembly
said walker assembly may be erected into a walker mode where said walker assembly is rotated away from said case assembly and erected to a height suitable to be used as a walker.

2. An ambulatory assistance device as in claim 1, wherein said case assembly may be sealed by means of a zipper.

3. An ambulatory assistance device as in claim 1, wherein said case assembly has four wheels on the lower edge of said case assembly.

4. An ambulatory assistance device as in claim 1, wherein said walker assembly further comprises a padded grip where a user of the device may grasp the walker assembly with their hands.

5. An ambulatory assistance device as in claim 1 wherein said walker assembly may be adjusted to any of several predetermined heights to accommodate different users of varying heights.

6. An ambulatory assistance device as in claim 1 wherein said studs in said walker assembly may be erected into said walker mode with the assistance of springs and spring clips locking into bores.

7. An ambulatory assistance device as in claim 1 wherein said walker assembly further comprises a friction brake connected to at least one of said wheels.
